(19) United States
(12) Patent Application Publication
(10) Pub. No.: US 2015/0198978 A1
(43) Pub. Date: Jul. 16, 2015

(54) ELECTRONIC DEVICE

(71) Applicant: Plastic Logic Limited, Cambridge, Cambridgeshire (GB)

(72) Inventor: Mark Catchpole, Cambridge (GB)

(21) Appl. No.: 14/420,307

(22) PCT Filed: Aug. 12, 2013
(86) PCT No.: PCT/GB2013/052145

§ 371 Date: Feb. 6, 2015

(30) Foreign Application Priority Data
Aug. 13, 2012 (GB) 1214425.9

(51) Int. Cl. G06F 1/16; G06F 3/14; G06F 3/041; G06F 3/03

(52) U.S. Cl. CPC G06F 1/1652; G06F 3/03; G06F 3/1423; G06F 3/041

(57) ABSTRACT

The invention provides a detachable flexible display device comprising: at least one electronic paper display screen; attachment means to attach said display device to a mobile electronic device; interfacing means to enable said device to communicate with said mobile electronic device; and wherein said device is convertible between a wrapped state and an unwrapped display state.

### FIELD OF THE INVENTION

This invention relates to flexible display devices, in particular for attachment to mobile electronic devices, and to mobile electronic devices combined with flexible display devices.

### BACKGROUND TO THE INVENTION

Increasingly, mobile electronic devices such as smartphones are used to view, create and edit documents or images. However, the typical area of a smartphone screen is not large enough to allow documents to be read easily. Thus, the invention provides a device to improve user experience of viewing and editing documents on their mobile electronic devices.

Background prior art can be found in EP1967937.

### SUMMARY OF THE INVENTION

According to a first aspect of the invention, there is provided a detachable flexible display device comprising: at least one electronic paper display screen; attachment means to attach said display device to a mobile electronic device; interfacing means to enable said device to communicate with said mobile electronic device; and wherein said device is convertible between a wrapped state and an unwrapped display state.

Broadly speaking, the invention provides a user of a mobile electronic device, such as mobile phone, with a larger additional and detachable display to allow the user to view and manipulate documents. The mobile electronic device may be, for example, a PDA (personal digital assistant), a mobile phone (in particular, a smartphone) or other such devices. Typically, the display area of a smartphone is not sufficient to allow whole documents or pages to be displayed and read with ease. Users may zoom in to a portion of a displayed page in order to read it, and must then zoom out and pan to a new portion of the page to continue reading. The detachable display device provides a solution to this problem without compromising on the mobility and dimensions of the mobile electronic device. The flexible display device is constructed primarily of plastic and is therefore, thin and light enough such that when wrapped around a mobile electronic device the dimensions of the mobile device are only increased by a few millimetres.

The flexible display device may be attached to a mobile electronic device when required or may also be attached to the mobile device when the mobile device is not in use. When attached to the mobile device, the display device can be wrapped around the mobile device when the phone is not being used, and can be unwrapped when required to view documents. Alternatively, the flexible display device can be detached from the mobile phone and used as a standalone display, as described below. Typically, the wrapped state is a wrapped storage state in which the display is stored ready for use. Alternatively, in the wrapped state, the display may be visible, i.e. can be active or activated, so that both the wrapped and unwrapped states are display states.

The electronic paper display screen may be monochrome or colour. The flexible electronic paper display screen may be electrophoretic display, electro-wetting display, electrofluidic display screen, flexible LCD or flexible OLED.

In a preferred embodiment, the attachment means of the detachable flexible display device comprises a magnetic strip along an edge of the display device. The magnetic strip may be physically adhered to the top of the display device. Preferably, the magnetic strip is incorporated within the thickness of the display device. The magnetic strip enables the display device to magnetically attach to a mobile electronic device that contains magnetic components.

In a preferred embodiment, the interfacing means of the detachable flexible display device comprises a wireless connection means for communication with a mobile electronic device. The wireless connection means includes electronics for a wireless link to a mobile device. The wireless link may be, for example, WiFi or Bluetooth™. In the case of a Bluetooth ™ link, the wireless connection means includes a Bluetooth ™ RF chip and antenna. The wireless link enables programs, data and documents to be transmitted from a mobile electronic device to the display device for display and editing, and for edited data and documents to be transmitted back to the mobile device. The wireless connection advantageously enables the display device to be used in combination with any mobile electronic device that has wireless capability, and circumvents the use of mobile device-specific physical connections between the display device and mobile device. As described above, this also enables the flexible display device to communicate with a mobile device when it is being operated in a standalone configuration (i.e. when it is not physically attached to the mobile device).

In a preferred embodiment, the wireless connection means enables automatic synchronisation and transfer of data between the display device and a mobile electronic device. This allows for example, document edits performed using the display device to be transferred to the mobile device automatically, providing a user with an efficient way to save documents.

In another preferred embodiment, the interfacing means of the detachable flexible display device comprises a wired connection means for communication with a mobile electronic device. The wired connection means may be for example, a USB or other docking connector. As described above, the wired connection enables programs and data to be transmitted and received between the flexible display device and the mobile electronic device. The wired connection means includes a USB to serial interface chip and other electronics to enable the interfacing.

In a preferred embodiment, the detachable flexible display device comprises a microprocessor and a user interface to enable said device to enable standalone operation when not interfaced with said mobile electronic device. As mentioned above, the flexible display device can be used when the display device is not attached or wirelessly connected to the mobile device. Software to drive the display may be located on the flexible display device and the mobile electronic device. The display device comprises a memory and a rechargeable battery such that documents can be stored in the display device for viewing or editing. The display device user interface allows a user to edit and save documents, which can be automatically transferred to a mobile device once the mobile device is wirelessly connected to the display device. In embodiments, the display device may comprise physical buttons located for example, along an edge of the display device, which enable the user to control the user interface.

The wired embodiment of the display device, as described above, may not include a rechargeable battery. In the wired embodiment, the display device is powered via the USB connection to the mobile electronic device and software to drive the display may be located on the mobile electronic device.

According to another aspect of the invention, there is provided a flexible display device comprising: at least one electronic paper display screen; interfacing means to enable said device to communicate with a mobile electronic device; wherein said electronic paper display screen is a touch screen; and wherein said device is convertible between a wrapped state and an unwrapped display state. In this aspect, the flexible display device is able to communicate with a mobile electronic device but is not necessarily attached to said device. At least one of the electronic paper display screens includes a touch-screen layer on a front surface, for example to operate with a stylus or a finger; this may be a projected capacitance touch sensing layer or an inductive stylus sensing layer.

The following features apply to both aspects of the invention.

In a preferred embodiment, the flexible display device comprises a first and a second electronic paper display screen to enable double-sided display. The display device can be rotated through 180° in a similar fashion to turning a page of a book, in order to view pages of a document. A subsequent page to that being viewed may be pre-loaded on the rear screen such that on rotating the display device, the user will be able to view this page without encountering a delay in the loading of the page on the electronic paper display.

In a preferred embodiment, the first display screen is a black and white display and the second display screen is a colour display. In another preferred embodiment, the first and second display screens have substantially similar resolutions. In an embodiment, at least one of width and length is smaller for said first display screen than said second display screen. A user of the flexible display device may be able to choose whether to display a page on the display screens as colour or black and white images, or as high or low resolution images, via a user interface.

In a preferred embodiment, the display device further comprises a protective layer such that in a wrapped storage state, the layer provides a protective casing around the mobile electronic device. The protective layer provides protection for both the attached mobile device wrapped within the display device and the electronic paper display. In embodiments, the protective layer may be comprised of a material that protects against impact. In embodiments, the protective layer may be a waterproof material. The display device may be sealed and may not have any external physical connectors, which prevents the electronics within the display device from coming into contact with precipitation.

In a preferred embodiment, the flexible display device comprises a motion detection means to detect physical rotation of said display device and configured to communicate said detection to a controller, wherein said controller enables pages of a displayed document to be turned. The motion detection means may be an accelerometer or similar motion sensors capable of automatically detecting rotation of the display device.

The motion detection means sends a signal to a controller when rotation has been detected, which causes the controller to update the pages that are displayed on the one or more electronic paper display screens. In the double-sided display embodiment of the invention, the controller is configured to pre-load a next page on the rear screen when the display device is rotated, as described below.

In a preferred embodiment, the controller is configured to display said pages of a displayed document on said double-sided display by: displaying a first page on said first display screen, wherein said first display screen is the current front screen; displaying a next page on said second display screen, wherein said second display screen is the current rear screen; receiving a signal from said motion detection means indicating said display device has been rotated and said second display screen which is the new front screen; pre-loading said new rear screen with a next page for display.

In a preferred embodiment, the display device comprises stiffened regions at one or more locations corresponding to the surfaces of said mobile electronic device and flexible regions at one or more locations corresponding to one or more edges of said mobile device around which said display device bends, wherein said stiffened regions reduce mechanical stress placed on said display and said flexible regions enable said display device to be converted to said wrapped storage state. The stiff regions do not need to be flexible, as in the wrapped state these regions are in contact with the surfaces of the mobile electronic device. By preventing these regions from flexing, unnecessary mechanical stress on the display device is reduced. The stiff regions may be stiffened by backing the flexible display device with a structural backing material layer in these regions. The flexible regions of the display device may also be backed with a similar structural layer. This would reduce the flexibility of the display device but would enable the display device to be flexible enough to bend into a fixed position during use, for example, at an angle to the attached mobile device to facilitate viewing of the display screen.

In a preferred embodiment, the flexible display attaches to an electronic device along an edge, wherein the display comprises at least one flexible band parallel to said edge, spread away from said edge, and at least one less flexible region between said flexible band and said edge, wherein said flexible device is configured such that, when wrapped around said mobile electronic device said flexible band wraps around an edge of said device.

In a preferred embodiment, the detachable flexible display device further comprises a flexible display structure, comprising: a transparent front panel; a flexible display screen and control electronics behind said front panel; a backing material sheet layer, wherein said backing layer is configured to provide said stiffened and said flexible regions. In embodiments, the battery for the display device may be rechargeable and may comprise a thin-film flexible battery such as a polymer battery. In embodiments, the display device includes an inductive loop to receive power for charging the display device. The control electronics may comprise a flexible printed circuit board (PCB).

Both the thin-film battery and the PCB may be arranged as layers behind the flexible display screen, or alternatively, may be located along an edge of the display device such that they are incorporated within the thickness of the display device.

In a preferred embodiment, the display device further comprises display driver chips positioned along one or more edges of said display device in said one or more stiffened regions.

In a preferred embodiment, the flexible display device further comprises a display backplane comprising organic active matrix pixel driver circuitry on a plastic substrate, and display interface electronics for said active matrix pixel driver circuitry; wherein said electronic paper display is mounted on said display backplane, wherein said plastic substrate extends beyond a border of said electronic paper display; and wherein at least a portion of said display interface electronics is fabricated on said plastic substrate in a said stiffened region of said display device.

In a preferred embodiment, the attachment means comprises a wireless dock device to physically hold said mobile electronic device. A mobile electronic device may slot into or sit within a recess in the display device which forms a dock device. The dock device does not comprise any electrical or physical connections to enable the mobile device to connect with the display device; rather, the mobile device connects wirelessly to the display device as described above.

In a preferred embodiment, the dock device comprises a rear panel and is physically configured to fit in around or against said mobile electronic device, wherein said electronic paper display is attached along one edge to said dock device, and wherein said dock device incorporates at least a portion of control electronics for said electronic paper display. In this embodiment, the electronic paper display screen is physically attached along an edge of the dock device, such that when a mobile device is docked, the display screen is adjacent to the mobile device. When the display screen is folded into the wrapped state, the display screen and the rear panel of the dock device may provide the mobile device protection against impact.

In a preferred embodiment, the flexible display device comprises: a flexible plastic substrate; an array of organic thin film transistors (TFTs) on said substrate; a layer comprising conductive tracks for addressing said array; a layer of electronic paper display medium over said array of organic TFTs; a front window over said electronic paper display medium; a layer of touch sensing tracks between said front window and said display medium; and further comprising a stripe of magnetic material mounted on a said substrate along an edge of said display, in particular within a thickness of the device.

In a preferred embodiment, the organic TFTs are mounted on a display backplane on said flexible plastic substrate; and the flexible display device further comprises: display interface electronics for said display, coupled to said display backplane; wherein said flexible plastic substrate extends beyond a border of said display; and wherein at least a portion of said display interface electronics is fabricated on said flexible plastic substrate.

In a preferred embodiment, the flexible display device comprises a discontinuous stripe of magnetic material. As described above, the magnetic strip may be physically attached to the substrate of the display device or preferably, may be incorporated within the thickness of the display device.

In a preferred embodiment, the electronic paper display is an electrophoretic display.

Electrophoretic displays are an example of reflective display mediums, which allow the display device to be used in bright light conditions, such as outdoors. A colour display may be provided by providing a colour filter array over the electrophoretic display medium.

In a preferred embodiment, the electronic paper display is an electrowetting or electrofluidic display. As above, these displays are reflective display mediums. Electrofluidic displays enable improved brightness/contrast as well as high resolution screens and near video display update rates. Where an electrofluidic display is employed, for example of the type available from Gamma Dynamics, Inc. Ohio USA, the colour filter array may be omitted. The use of an electrofluidic display facilitates improved brightness/contrast as well as near video display update rates and high resolution, in embodiments of order 225 pixels per inch.

In a preferred embodiment, the electronic paper display is a flexible LCD or flexible OLED.

In a preferred embodiment, the mobile electronic device is in combination with the display device such that in the wrapped storage state the display screen is wrapped around the mobile electronic device, and in the unwrapped display state the display screen is at least partially unwrapped from the mobile electronic device. As described above, the flexible display device may be attached to a mobile electronic device when required or may also be attached to the mobile device when the mobile device is not in use. Thus, both the mobile device and the display device can be stored together when not in use. According to a related aspect of the invention, there is provided a flexible display configured to wrap around a mobile electronic device, the display comprising: a processor and, coupled to said processor, data memory, program memory first and second electronic paper displays, an external interface to receive data for display from said mobile electronic device, and a motion sensor to identify motion of said flexible display; wherein said first and second electronic paper displays are on first and second regions of said display; and wherein said program memory stores processor control code to: receive image data for display; process said image data to partition said image data into first and second portions; process a signal from said motion detector to determine when said display is moved such that of said first and second electronic paper displays become visible and a second of said electronic paper displays is hidden; update said hidden one of said electronic paper displays with said first portion of said image data.

As described above, the display device may comprise two electronic paper display screens on opposite sides of the display device to allow double-sided display. The two screens can be used to display a page and a subsequent page of a document, and the displays can be updated when rotation of the display device is detected. Preferably, the two screens can be used to display portions of a page, document or image. The display device controller may be configured to receive a page or image for display from the mobile device and divide the page or image into two portions for display on the two screens. This may be particularly useful when viewing spreadsheets or large images which are not easily viewed on one screen. By way of example only, the following describes how the display device may be used to facilitate viewing of a document. A user of the display device may wish to view or edit an Excel TM workbook. The workbook consists of several spreadsheets which are individually too large to display on one of the electronic paper display screens. In this example case, the controller receives the workbook from the mobile electronic device and selects a spreadsheet to display. The controller divides the spreadsheet into two portions and displays the first portion on the front display screen and the second portion on the rear display screen. When the user rotates the display device to look at the second portion, the motion sensor sends a signal to the controller indicating that the new rear display screen needs to be updated. The controller may then select another spreadsheet from the workbook to display, and divides the spreadsheet into two portions as before. The first portion of this new sheet is pre-loaded onto the new rear display screen so that the user will be able to view the portion as soon as he rotates the display device again. In this way, large documents can be viewed on the display device without the user experiencing a noticeable delay in the updating of the displays.

In a preferred embodiment, the code is further configured to determine when said visible electronic paper display becomes hidden, and to update said newly hidden electronic paper display with said second portion of said image data.

In a preferred embodiment, the first and second electronic paper displays are on opposite sides of said flexible display. As described above, this enables double-sided display which may facilitate the reading of a document.

In a preferred embodiment, the flexible display is detachable from said mobile electronic device. As described above, this allows the flexible display device to be stored separately from the mobile electronic device or to operate as a standalone display device.

The above described aspects and embodiments of the invention may be combined in any permutation.

### BRIEF DESCRIPTION OF THE DRAWINGS

The invention is diagrammatically illustrated, by way of example, in the accompanying drawings, in which:

FIGS. 1a and 1b show rear and front perspective views of a flexible display device in an unwrapped display state;

FIGS. 1c and 1d show rear and front perspective views of the flexible display device of FIG. 1a in a wrapped storage state;

FIGS. 2a to 2d show the flexible display device of Figure la coupled to a mobile electronic device in a wrapped storage state, a first partially unwrapped display state, a second partially unwrapped display state and a fully unwrapped display state;

FIGS. 3a and 3b show an alternative flexible display device coupled to a mobile device in an unwrapped display state and a wrapped storage state respectively;

FIG. 4 shows a schematic of the structure of the display device;

FIG. 5 shows a block diagram of the device;

FIG. 6 is a flow diagram of the process to display images on a double-sided display device;

FIG. 7 shows a detailed vertical cross-section view through an embodiment of the display device;

FIG. 8 shows a simple cross-section view and top view of the display device;

FIG. 9 shows a schematic of the internal arrangement of the display interface electronics; and

FIG. 10 shows an embodiment of the flexible display device with an exposed display.

### DETAILED DESCRIPTION OF PREFERRED EMBODIMENTS

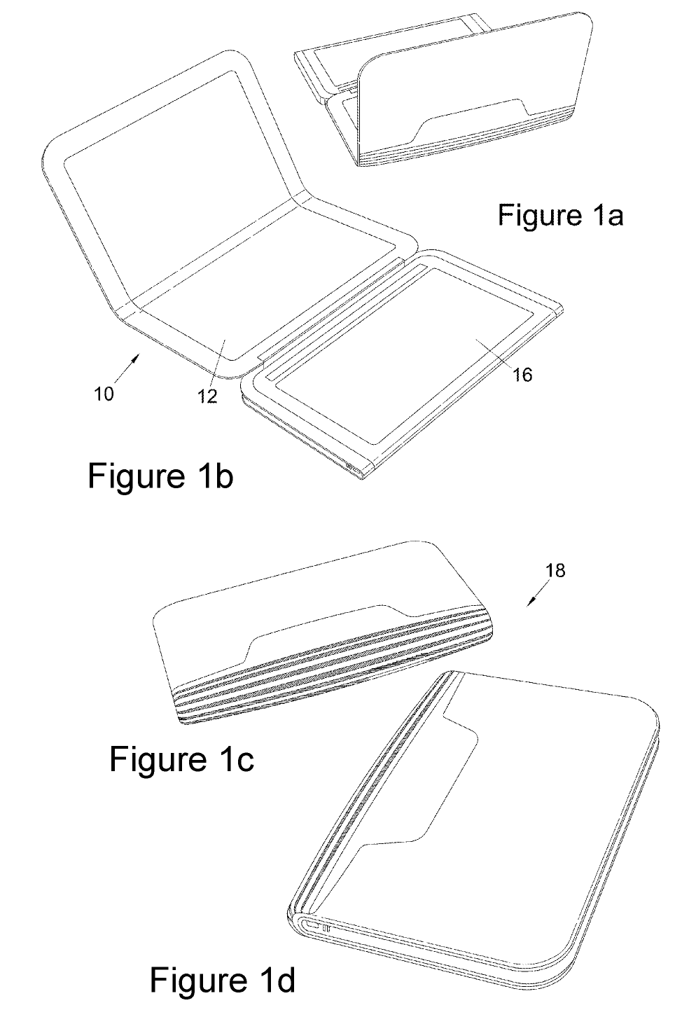

FIGS. 1a to 3b show preferred embodiments of a detachable flexible display device 10. The display device 10 provides an additional display screen 12 for mobile electronic devices 14 such as for example, smartphones. The additional display may be several times larger than the area of a typical mobile phone display, allowing users to easily view images or documents which would be difficult to read without repeated zooming and panning on a mobile phone display.

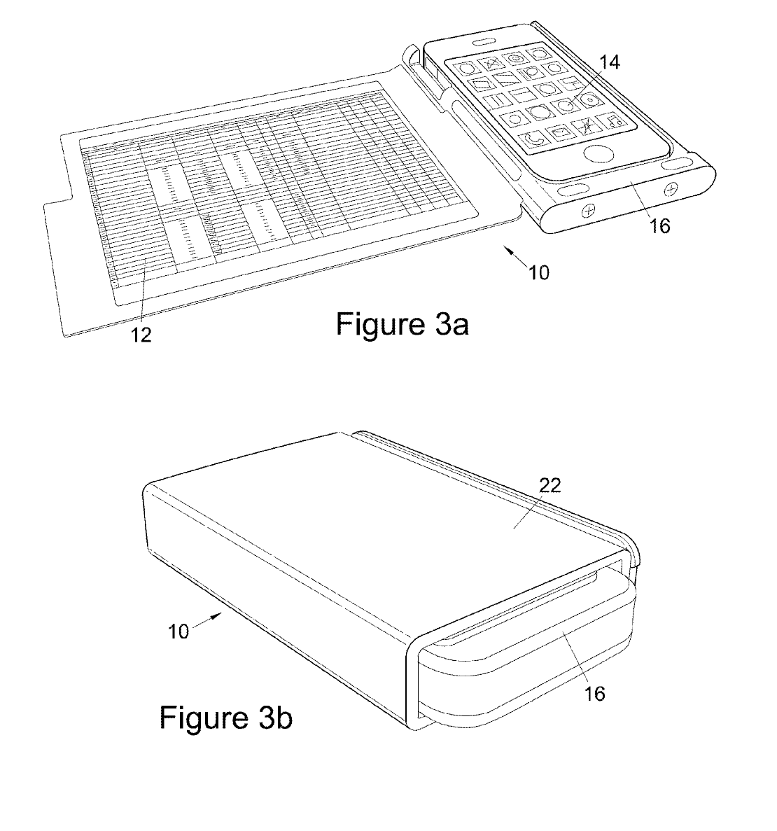

In embodiments, the display device 10 comprises a dock device 16 which allows a mobile electronic device 14 to be mechanically attached to the display device. As shown in FIGS. 1a and 3a, a mobile electronic device 14 can slot or sit in the recessed dock device 16. Preferably, the mobile device 14 does not electrically connect to the display device 10; rather, the mobile device 14 connects wirelessly to the display device as described further below. The display screen 12 is mechanically attached to the dock device 16 by means of a hinge or similar mechanism, which enables the screen to fold around the dock device.

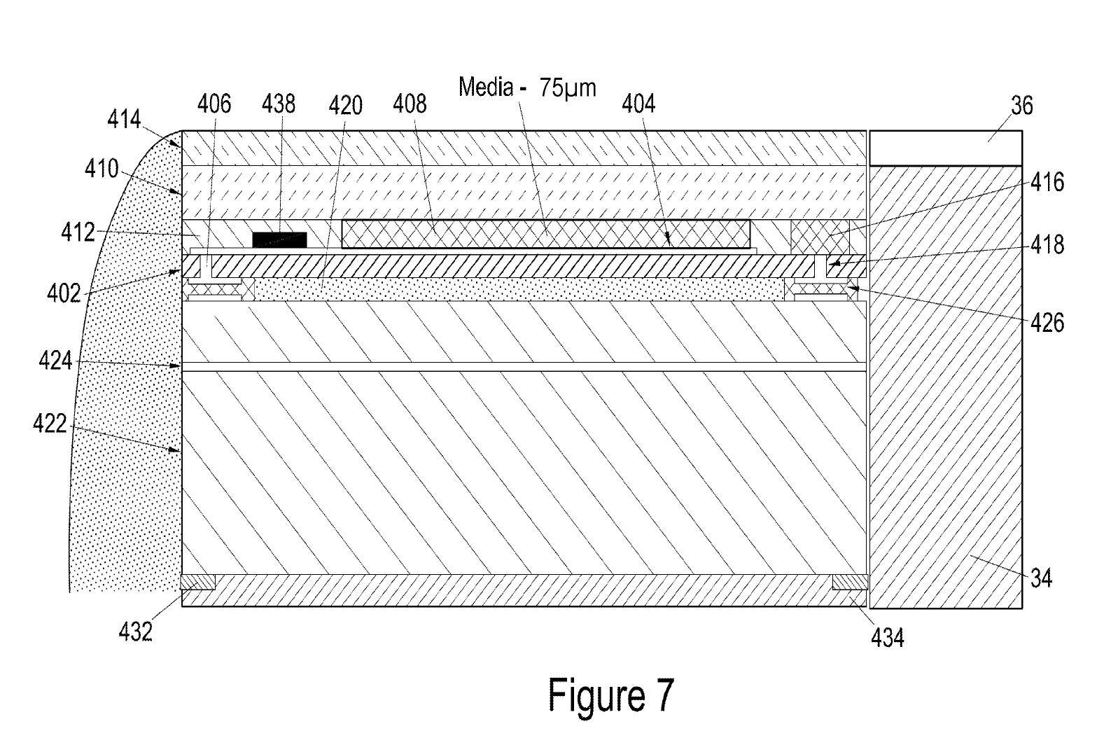

In alternative embodiments, the display device 10 may attach to a mobile device 14 by means of a magnetic strip, which is mounted on a substrate of the display device (as described below with reference to FIG. 7). Alternatively, small magnets may be attached to the inside of a mobile device casing by the user. The display device may comprise magnets attached at corresponding positions on the inside of the display device (for example, along one or more edges of the device and preferably within the display device assembly), such that the magnets of the mobile device and display device align when the display device is attached to the mobile device.

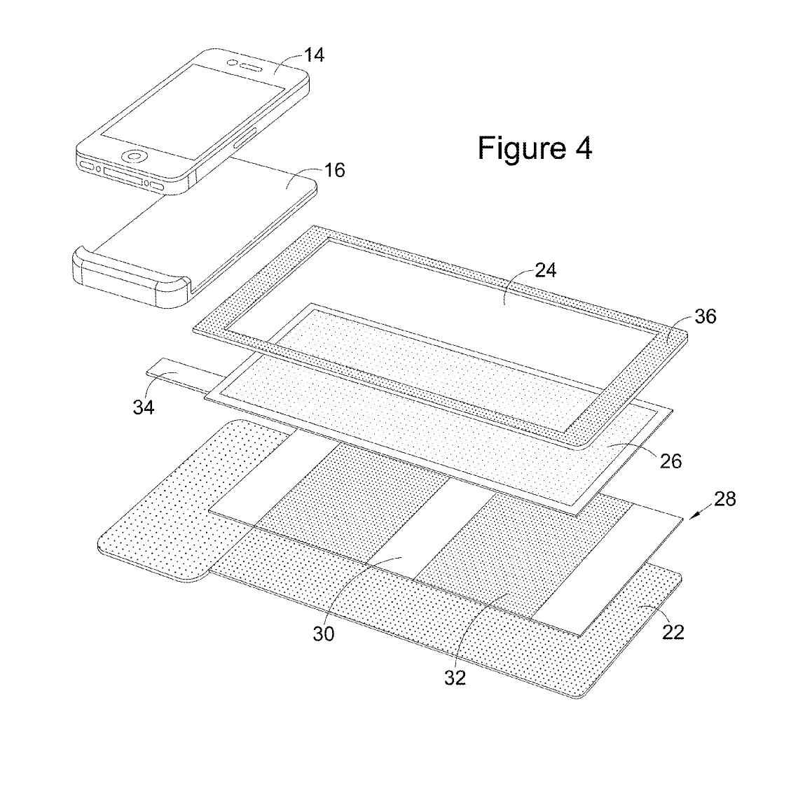

In an alternative embodiment, the flexible display device 10 comprises a USB or docking connector 34 (as shown in FIG. 4) to enable the display device 10 to electrically connect to a mobile electronic device 14. The docking connector 34 and the display control and power electronics may be located within the dock device 16.

Each of these attachment mechanisms allow the display device 10 to be attached to the mobile electronic device 14 when required to provide an additional, larger display screen, and to be detached when the user does not require an additional screen.

The flexible display device can be converted between a wrapped state 18 as shown in FIG. 1b and an unwrapped state as shown in FIG. 1a. In the wrapped state 18, the flexible display screen 12 is wrapped around the mobile electronic device, which allows the display device and the mobile electronic device to be stored together when not in use. The flexible display screen is thin and, in the wrapped state, does not significantly increase the dimensions of the mobile electronic device. As shown in FIGS. 1a to 3b, there are a number of possible configurations of the display device. The display screens 12 of FIGS. 1 a to 2d are less flexible than that shown in FIGS. 3a and 3b.

The display screens of FIGS. 1 a to 2d can be unfolded to be substantially flat or unfolded into a bent configuration. This is facilitated by the structure of the display device, as described further below.

In the embodiments depicted in FIGS. 1a to 3b, the flexible display screen is generally hidden when the device is in the wrapped state, i.e. the screen is stored. A further embodiment illustrated in FIG. 10 shows a flexible display device in a wrapped state 18. Here, the flexible display screen 12 is wrapped around the mobile electronic device such that the screen is exposed. This may allow a user to view the documents on the screen even when the flexible display device is in the wrapped state. Rotating the flexible display device through 180° in a similar fashion to turning a page of a book, may allow the user to view pages of a document, as described above. For example, a subsequent page to that being viewed on the front screen (i.e. the portion of the screen visible in FIG. 10) may be pre-loaded on the rear screen (i.e. the portion of the screen not visible in FIG. 10), such that on rotating the display device, the user will be able to view this page without encountering a delay in the loading of the page. It is noted that in this wrapped state, although the display screen is active, the display screen may still be considered to be in a storage state because the mobile electronic device is stored within the wrapped screen.

The flexible display screen 12 may be an electrophoretic display. Typically, mobile electronic device display screens are emissive displays which may make the screen difficult to view in bright light (for example, when outside). Electrophoretic displays are reflective rather than emissive, allowing a user to view documents and images on their mobile electronic device outside. The display screen may also be an electrowetting or an electrofluidic display, which are both reflective display mediums.

FIG. 3b also shows an embodiment of the invention in which the display device 10 provides the mobile electronic device with a protective casing 22. The protective casing may protect the mobile device located within the dock device 16 against impact or may provide a waterproof outer layer.

FIG. 4 illustrates the structure of an embodiment of the display device. The display device comprises a transparent front panel 24, a flexible display screen and a touch sensitive layer 26, a structural backing layer 28 and a protective layer 22. The dock device 16 is mechanically connected to the display screen by means of a hinge or otherwise. The display device may also comprise a flexible connector 34 which connects a mobile electronic device 14 to the dock device 16 and the driver chips of the display device. In a wired embodiment, the flexible connector 34 enables the mobile electronic device to power the display device. In a wireless embodiment, the flexible connector 34 connects the control electronics located within the dock device 16 to the driver chips. Display driver chips typically run along at least two sides of a display screen, which minimises the routing required between the driver chip and the display screen. This allows larger display screens and smaller bezels. A thin, flexible plastic bezel 36 covers the edge of the flexible display screen 24.

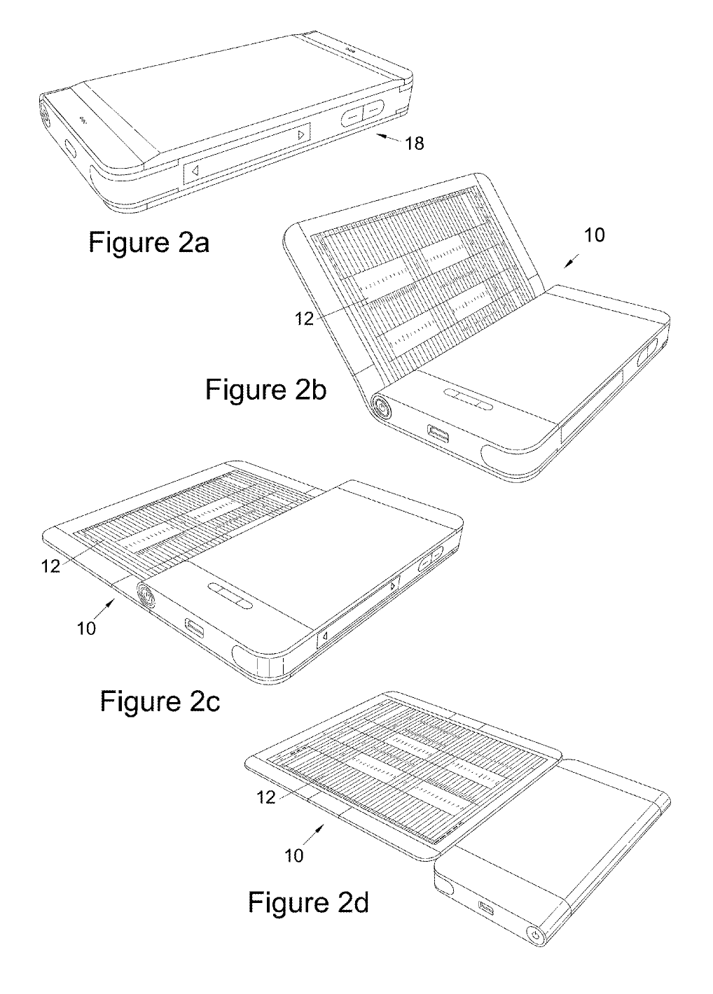

The backing layer 28 of the display device may allow the display screen to be entirely flexible (as shown in FIGS. 3a and 3b). Alternatively, for the embodiment illustrated in FIGS. 1a to 2d, the backing layer 28 may comprise stiffened regions 32 at one or more locations corresponding to the surfaces of a mobile electronic device 14 and flexible regions 30 at one or more locations corresponding to one or more edges of the mobile device 14 around which the display device bends. The stiffened regions 32 reduce mechanical stress placed on the display and the flexible regions 30 enable the display device to be converted to the wrapped storage state. The backing material layer 28 therefore allows regions to be stiffened or kept flexible as required. In a preferred embodiment, the display driver chips may be positioned along at least two sides of the display device within one or more of the stiffened regions 32. The flexible regions 30 may also be backed with a structural layer. This reduces the flexibility of the display device but enables the display device to be flexible enough to bend into a fixed position during use, for example, at an angle to the attached mobile device to facilitate viewing of the display screen, as shown in FIGS. 1a and 1b. The flexible display device of FIG. 1a would comprise only one flexible region 30 as the display device has only one fold. Plastic snap connectors (not shown) may attach the bezel 36 to the plastic protective layer 22 and hold the assembly together. Layers within the display device may be held within the assembly using an adhesive material.

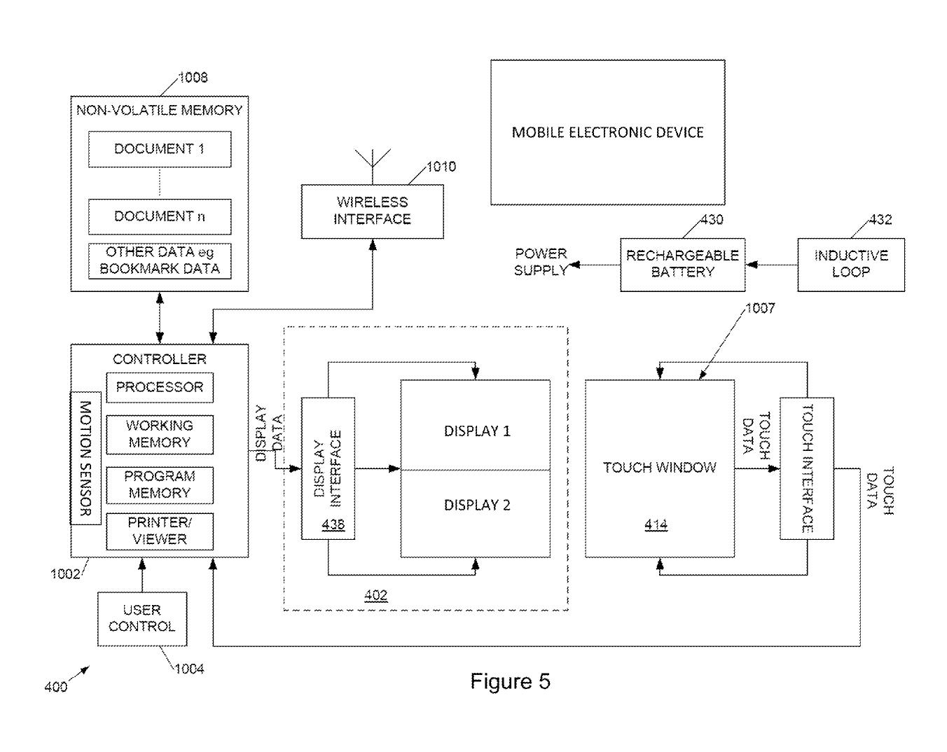

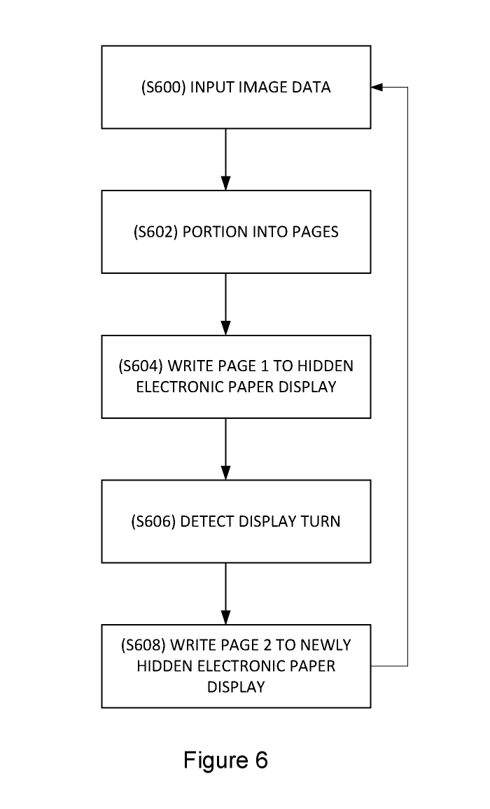

FIG. 5 shows a block diagram of the electronics of the display device. The device comprises a controller 1002 which includes a processor, for example an ARM ™ device, working memory and program memory coupled to one or more display interface integrated circuits 438 for driving the electronic paper display 408. One or more touch interface integrated circuits 1006 interface with the touch electrodes on front window 414 to provide touch data to controller 1002. The controller also includes a motion sensor which is capable of detecting when the display device is rotated, as described above. Operation of the controller is further described below with reference to FIG. 6.

In a wired embodiment of the display device, in which the display device connects to the mobile electronic display via a wired connection, the display device may not comprise a rechargeable battery 430 and inductive loop 432. In this case, the display device is powered via the USB connection.

The program memory in embodiments stores processor control code to implement functions including an operating system, various types of wireless and wired interface, document retrieval, storage, annotation (via the touch interface) and export from the device. The stored code also includes code 1003 to implement a document viewer/'printerless printing' function, for example interfacing with corresponding driver code on a ‘host’ device.

The controller 1002 interfaces with non-volatile memory, for example Flash memory, for storing one or more documents for display and, optionally, other data such as user bookmark locations and the like. Optionally a mechanical user control 1004 may also be provided.

A wireless interface 1010, for example a Bluetooth™ or WiFi interface is provided for interfacing with a mobile electronic device. For example, the wireless interface can be used by the display device to receive image data from the mobile electronic device and transmit touch data back to the mobile device. The wireless interface 1010 may comprise a Bluetooth™ RF chip and antenna.

As previously mentioned inductive loop 432 is used to charge the rechargeable battery 430 which has associated circuitry for providing a regulated power supply to the system.

FIG. 6 shows a flow diagram of the process to display images on a double-sided display device. As described earlier, image data is received by the display device via the wireless interface. The controller is configured to divide the image data at step S602 into portions for display on the two screens of the display device, such that images are pre-loaded on the rear, hidden screens to allow a use to rotate the device and immediately view the image portion. The process illustrated in FIG. 6 assumes that there is already a page or image displayed on the front screen. A first portion of the received image data is then displayed on the hidden screen at step S604 and is ready for the user to view when she rotates the display device. At step S606, when the display device is rotated, the motion sensor of the controller detects that the device has been rotated and communicates this to the controller. This prompts step S608, which causes the controller to display the second portion of the image data on the newly hidden, rear display screen. This process is repeated and thus, portions of received data are automatically available for a user to view each time the display device is rotated.

FIG. 7 shows a vertical cross-section view through an embodiment of the flexible display device, in which electronic components of the device are located along an edge of the device on a flexible PCB. A display medium 408 is attached to substrate 402, for example by adhesive. As described above, the display medium is a reflective display medium (which facilitates daylight reading), for example an electrophoretic display medium or an electrofluidic display medium. A front window 414 is provided over the display, for example comprising a thin layer of PMMA (polymethylmethacrylate). Where the device is touch sensitive, this layer may also include conductive row and column lines for the touch circuitry. The touch sensing circuitry may be operable by finger and/or a stylus. A connection to the touch sensing layer may be made by a Z-axis conductive pad 416 which connects to the touch electrodes in window 414 through CFA/encapsulation layer 410 (for example by vias, not shown) and vias 418 through substrate 402 bring the touch array connections to contact pads on the rear of substrate 402.

An adhesive layer 420 connects the substrate 402 to a flexible PCB 422 (which may incorporate circuitry 424 for an inductive stylus sensor. Connections between the contact pads on the rear of substrate 402 and the flexible PCB employ an anisotropic conductive film (ACF) 426. The illustrated structure facilitates the omission of a separate moisture barrier under substrate 402, although such a barrier may be incorporated if desired.

A flexible PCB 34 carries electronic components, for example surface mounted components, and a thin film flexible polymer battery. Flexible PCB 34 also bears a conductive loop 432 around the border of the device for inductive charging of battery 430. A storage device may also be carried on the flexible PCB. A thin back cover 434 may be used to provide a protective layer as described above, which may protect against impact or be waterproof. A magnetic strip 36 may be mounted along an edge of the substrate. The magnetic strip 36 may protrude from the substrate or as shown in FIG. 7, may preferably be within a thickness of the device.

As described above, a wired embodiment of the flexible display device may not comprise a battery or a conductive loop to charge the battery. The wired embodiment comprises a flexible PCB that carries a high voltage power management IC, a USB to serial interface chip, a USB connector and a complex programmable logic device (CPLD).

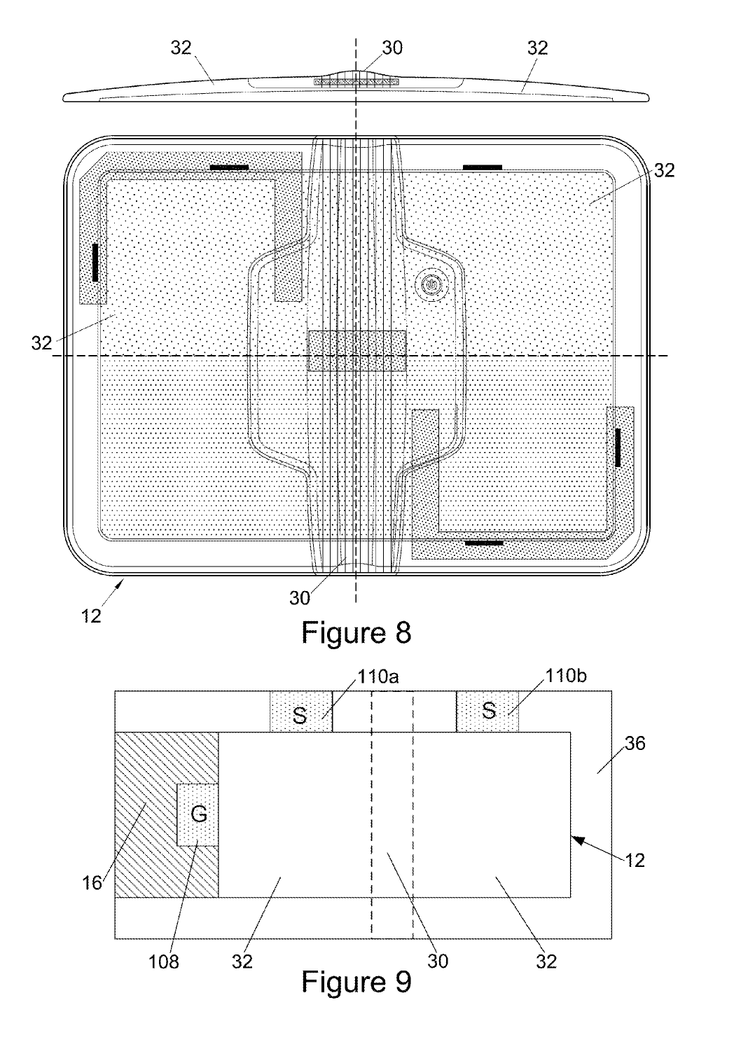

FIG. 8 shows a simple cross-sectional view of the display screen portion of the display device illustrated in FIG. 1a. As described earlier with reference to FIG. 4, the display device may be comprised of flexible regions 30 and stiff regions 32. In the example shown here, there is one flexible region 32, which allows the screen 12 to fold into two, as shown in FIG. 1a.

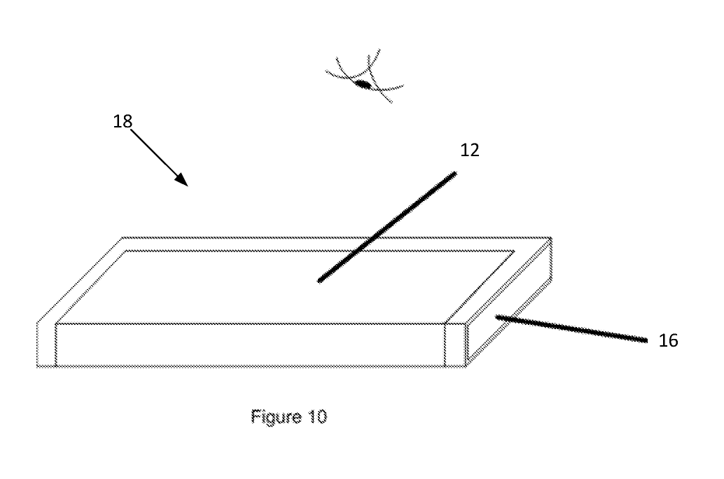

FIG. 9 shows an internal arrangement of the display interface electronics for the device of FIG. 4. As illustrated in FIG. 9 the display interface electronics comprises a gate driver integrated circuit 108 and first and second source driver integrated circuits 110a, b. In embodiments the source lines of the display are driven from one edge of the display and the gate lines are driven from the an adjacent edge of the display, and thus the first and second source driver integrated circuits 110a, b may advantageously be located in the stiffened regions of the display.

The flexible display device may be used for a number of purposes, including, but not limited to:
Viewing photographs—full size images can be displayed on the display device and the display device can be passed around a group of people like a traditional paper photograph;
Spreadsheet editing—a spreadsheet can be displayed on the display device in landscape orientation, and the qwerty keypad on the mobile electronic device or on the phone may be used to perform the editing;
Word processing—documents can be displayed and edited on the display screen in a similar manner to spreadsheet editing;
Reading documents—a single page of a book or document can be displayed on the display screen, where pages can be turned using a button or a touch screen, or by rotating the display device if double-sided display is being used;
Smart electronic device casing—the display device can be used to check for new messages and emails as well as review social media feeds, advertising, personal photos and so on when a display screen of the display device faces outwards. The casing can be customised to give the casing different effects (such as a leather effect look) when not being used as a screen.
Location-based services—the display device can be used to display a map, which may show routes to a destination and may use the GPS feature of the mobile electronic device to update the map.

No doubt many other effective alternatives will occur to the skilled person. It will be understood that the invention is not limited to the described embodiments and encompasses modifications apparent to those skilled in the art lying within the spirit and scope of the claims appended hereto.

1. A detachable flexible display device comprising:
at least one electronic paper display screen;
attachment means to attach said display device to a mobile electronic device;
interfacing means to enable said device to communicate with said mobile electronic device; and
wherein said device is convertible between a wrapped state and an unwrapped display state.

2. The detachable flexible display device as claimed in claim 1 wherein said attachment means comprises a magnetic strip along an edge of the display device.

3. (canceled)

4. The detachable flexible display device as claimed in claim 1 wherein said interfacing means comprises a wireless connection means for communication with said mobile electronic device.

5. The detachable flexible display device as claimed in claim 4 wherein said wireless connection means enables automatic synchronisation and transfer of data between said display device and said mobile electronic device.

6. The detachable flexible display device as claimed in claim 1 wherein said device comprises a microprocessor and a user interface to enable said device to enable standalone operation when not interfaced with said mobile electronic device.

7. The detachable flexible display device as claimed in claim 1 comprising a first and a second electronic paper display screen to enable double-sided display.

8. The detachable flexible display device as claimed in claim 7 wherein said first display screen is a black and white display and said second display screen is a colour display.

9. The detachable flexible display device as claimed in claim 7 wherein said first and second display screens have substantially similar resolutions.

10. The detachable flexible display device as claimed in claim 7 wherein at least one of width and length is smaller for said first display screen than said second display screen.

11. The detachable flexible display device as claimed in claim 1 wherein said display device further comprises a protective layer such that in said wrapped storage state, said layer provides a protective casing around said mobile electronic device.

12. (canceled)

13. The detachable flexible display device as claimed in claim 11 wherein said protective layer comprises a waterproof material.

14. The detachable flexible display device as claimed in claim 1 wherein said display device further comprises a motion detection means to detect physical rotation of said display device and configured to communicate said detection to a controller, wherein said controller enables pages of a displayed document to be turned.

15. The detachable flexible display device as claimed in claim 14 wherein said controller is configured to display said pages of a displayed document on said double-sided display by:
displaying a first page on said first display screen, wherein said first display screen is the current front screen;
displaying a next page on said second display screen, wherein said second display screen is the current rear screen;
receiving a signal from said motion detection means indicating said display device has been rotated and said second display screen which is the new front screen; pre-loading said new rear screen with a next page for display.

16. The detachable flexible display device as claimed in claim 1 wherein said display device comprises one or more stiffened regions at one or more locations corresponding to surfaces of said mobile electronic device, one or more and flexible regions at one or more locations corresponding to one or more edges of said mobile device around which said display device bends, wherein said stiffened regions reduce mechanical stress placed on said display and said flexible regions enable said display device to be converted to said wrapped state.

17. The detachable flexible display device as claimed in claim 1 wherein said display attaches to said electronic device along an edge, wherein the display comprises at least one flexible band parallel to said edge, spread away from said edge, and at least one less flexible region between said flexible band and said edge, wherein said flexible device is configured such that, when wrapped around said mobile electronic device said flexible band wraps around an edge of said device.

18. The detachable flexible display device as claimed in claim 16 or further comprising a flexible display structure, comprising:
a transparent front panel;
a flexible display screen and control electronics behind said front panel;
a backing material sheet layer, wherein said backing layer is configured to provide said stiffened and said flexible regions.

19. The detachable flexible display device as claimed in claim 16 wherein said display device further comprises display driver chips positioned along one or more edges of said display device in said one or more stiffened regions.

20. The detachable flexible display device as claimed in claim 16 further comprising a display backplane comprising organic active matrix pixel driver circuitry on a plastic substrate, and display interface electronics for said active matrix pixel driver circuitry; wherein said electronic paper display is mounted on said display backplane, wherein said plastic substrate extends beyond a border of said electronic paper display; and wherein at least a portion of said display interface electronics is fabricated on said plastic substrate in a said stiffened region of said display device.

21. The detachable flexible display device as claimed in claim 1 wherein said attachment means comprises a wireless dock device to physically hold said mobile electronic device.

22. The detachable flexible display device as claimed in claim 21 wherein said dock device comprises a rear panel and is physically configured to fit in, around or against said mobile electronic device, wherein said electronic paper display is attached along one edge to said dock device, and wherein said dock device incorporates at least a portion of control electronics for said electronic paper display.

23. The detachable flexible display device as claimed in claim 1 wherein said display device comprises:
a flexible plastic substrate;
an array of organic thin film transistors (TFTs) on said substrate;
a layer comprising conductive tracks for addressing said array;
a layer of electronic paper display medium over said array of organic TFTs;
a front window over said electronic paper display medium;
a layer of touch sensing tracks between said front window and said display medium; and
further comprising a stripe of magnetic material mounted on a said substrate along an edge of said display, in particular within a thickness of the device.

24. The detachable flexible display device as claimed in claim 23,
wherein said organic TFTs are mounted on a display backplane on said flexible plastic substrate; and further comprising:
display interface electronics for said display, coupled to said display backplane;
wherein said flexible plastic substrate extends beyond a border of said display; and
wherein at least a portion of said display interface electronics is fabricated on said flexible plastic substrate.

25. The detachable flexible display device as claimed in claim 23 wherein said stripe of magnetic material is discontinuous.

26. The detachable flexible display device as recited in claim 1 wherein said electronic paper display is an electrophoretic display.

27. The detachable flexible display device as recited in claim 1 wherein said electronic paper display is an electrowetting, electrofluidic, flexible LCD or flexible OLED display.

28. The detachable flexible display device as recited in claim 1 wherein said display screen is arranged to display information both in said wrapped state and in said unwrapped state.

29. A mobile electronic device in combination with the display device of claim 1, wherein
in said wrapped state said display screen is wrapped around said mobile electronic device, and wherein
in said unwrapped display state said display screen is at least partially unwrapped from said mobile electronic device.

30. A flexible display configured to wrap around a mobile electronic device, the display comprising:
a processor and, coupled to said processor, data memory, program memory first and second electronic paper displays, an external interface to receive data for display from said mobile electronic device, and a motion sensor to identify motion of said flexible display;
wherein said first and second electronic paper displays are on first and second regions of said display; and
wherein said program memory stores processor control code to:
receive image data for display;
process said image data to partition said image data into first and second portions;
process a signal from said motion detector to determine when said display is moved such that of said first and second electronic paper displays become visible and a second of said electronic paper displays is hidden;
update said hidden one of said electronic paper displays with said first portion of said image data.

31.-33. (canceled)
